(19) United States
(12) Patent Application Publication
(10) Pub. No.: US 2013/0149673 A1
(43) Pub. Date: Jun. 13, 2013

(54) TRUCK DRIVING SIMULATOR AND TRAINING METHOD

(71) Applicant: James E. MILLER, Florence, SC (US)

(72) Inventor: James E. MILLER, Florence, SC (US)

(21) Appl. No.: 13/763,201

(22) Filed: Feb. 8, 2013

Related U.S. Application Data
(63) Continuation-in-part of application No. 12/833,397, filed on Jul. 9, 2010.

(51) Int. Cl. G09B 9/05

(52) U.S. Cl. CPC G09B 9/05
USPC 434/69

(57) ABSTRACT

A truck driving simulator is provided, comprising a simulated cab with a steering wheel and dashboard layout, foot pedals (accelerator, clutch, brake), gear shifting mechanism, and a video screen. In another embodiment, a series of such simulators may be placed in a classroom together with a single large screen video monitor or television at the front of the class, so that multiple students can follow along with the video simulation under the supervision of a teacher or instructor. The video monitor(s) may be used to show video footage of the actual route that will be used to test the drivers for their trucker's license. This arrangement allows students to repeatedly practice driving the actual course used for their driver's license test, and to learn concepts like clutching, double clutching and switching gears without risking damage to an actual truck and transmission.

### RELATED APPLICATIONS

This patent application is a continuation-in-part of U.S. application Ser. No. 12/833,397, filed on Jul. 9, 2010.

### BACKGROUND OF THE INVENTION

The present invention relates generally to truck driving simulators and teaching methods. More specifically, the present invention includes in one embodiment a truck driving simulator comprising a simulated cab with a steering wheel and dashboard layout, foot pedals (accelerator, clutch, and brake), gear shifting mechanism, and a video screen. In another embodiment, a series of such simulators may be placed in a classroom together with a single large screen video monitor or television at the front of the class, so that multiple students can follow along with the video simulation under the supervision of a teacher or instructor. The video monitor(s) may be used to show video footage of the actual route that will be used to test the drivers for their trucker's license. This arrangement allows students to repeatedly practice driving the actual course used for their driver's license test, and to learn concepts like clutching, double clutching and switching gears without risking damage to an actual truck and transmission.

Heretofore, many types of vehicle driving simulators have been developed and made commercially available or driving schools and institutions. Most such simulators include very complicated computer software and hardware, and each unit is very expensive. U.S. Pat. No. 3,896,564 discloses an apparatus for use in the training of operators of trucks or other vehicles having manual transmissions, wherein the apparatus includes a transmission control simulator plus logic elements to generate appropriate signals corresponding to the simulated operation of the vehicle.

U.S. Pat. No. 3,936,955 is directed to a driver training simulator apparatus that includes a console having a brake pedal, clutch pedal, steering wheel and accelerator pedal adjacent a small-scale model of a typical driving environment with streets, houses, trees and the like, through which the student is to drive a model vehicle. U.S. Pat. No. 4,464,117 describes an apparatus for vehicle driving simulation including a cabin capable of being swiveled and having therewith a screen, control devices and a driver's seat, from where the road picture can be observed and controlled. Another pair of patents, U.S. Pat. Nos. 4,949,119 and 5,197,003 disclose an apparatus for creating a realistic feel for a simulated gearshift, comprising a simulated gearshift for a simulated transmission in a simulated vehicle and having a gearshift lever and a shift pattern for simulating the look and movements through an actual shift pattern of an actual gearshift in a vehicle. In the '119 patent, a control computer is coupled to a strain gauge (which senses the degree of strain in the gearshift lever) and generates a signal telling whether an operator is pulling or pushing on the gearshift lever and in what direction.

However, none of the prior art provides a simplistic simulator and teaching method wherein a series of simulated truck cabs are provided together with a single video screen, and particularly wherein the video monitor is used to display video footage of the actual route that the drivers will follow during the test for their trucking license, or actual footage of a particularly troublesome portion of an upcoming run.

### BRIEF SUMMARY OF THE INVENTION

In accordance with one aspect of the invention, a truck driving simulator and teaching method is provided in order to provide effective instruction to students about operating an eighteen wheeler style truck (also commonly called semi-trucks, tractor trailers, and semi-trailers) without risking damage to an actual vehicle or transmission. In one embodiment, a simulator includes a driver's seat, a steering wheel attached to a simulated dashboard, foot pedals (accelerator, brake, clutch), a gearshift mechanism with a high/low gear indicator, and a video monitor. The video monitor is used to show footage that simulates driving through a road course, so that a student sitting in the simulator can simply follow along with the video footage by simulating or mimicking all of the activities associated with driving the truck.

During the training, the student driver turns the steering wheel at the appropriate times while following along with the video on the monitor, shifts gears through an appropriate shift pattern, accelerates, brakes and identifies road signs, bridge clearances, and other important signs, all under the supervision of an instructor. Preferably, the video includes actual footage from the road course that will be used to test the student for his or her truck driver's license. This arrangement allows a close simulation of the driver's test, including not only instruction from the instructor, but also questions from the instructor that may simulate questions asked by the examiner during the test. Additionally, the video screen may be used to show actual footage of a particularly troublesome or tricky portion of an upcoming run, so that a driver may practice and familiarize himself with that portion of the route, be familiar with it, and prepared to handle it safely and efficiently.

Thus, it is an object of the present invention to provide an inexpensive truck simulator that closely resembles the inside of an eighteen-wheeler style truck.

Another object of the present invention is to provide a method of instructing students in the operation of eighteen-wheeler type trucks, where a video monitor provides actual footage of a driving course, and wherein an instructor is available to offer instruction, critique, and to ask the student questions in an effort to simulate questions that may be posed by an actual examiner during the driver's test required for licensing.

Yet another object of the present invention is to provide a method of instructing drivers in the operation of vehicles, where a video monitor provides actual footage of a driving course that will be used for the driver's test, or where a video monitor provides actual footage of a particularly troublesome or tricky portion of an upcoming route.

Still another object of the present invention is to provide a method of instructing students in the operation of eighteen-wheeler type trucks, wherein the instruction includes teaching methods of clutching, double clutching and shifting gears without risking damage to an actual truck and transmission.

### BRIEF DESCRIPTION OF THE DRAWINGS

These and other features, aspects, and advantages of the present invention will become better understood with regard to the following description, appended claims, and accompanying drawings where:

FIG. 1 is a side view of one embodiment of a truck driving simulator having a driver's seat, a steering wheel and dashboard, foot pedals, a fire extinguisher, horn, mirrors and a video monitor;

FIG. 2 is a front view of one embodiment of a truck driving simulator;

FIG. 3 is a perspective view of one embodiment of a gear shift assembly that forms a part of a truck driving simulator;

FIG. 4 is a side view of one embodiment of a truck driving simulator;

FIG. 5 is a rear view of one embodiment of a truck driving simulator;

FIG. 6 is an illustration of one embodiment of an electrical schematic drawing associated with a truck driving simulator;

FIG. 7 is a cut-away rear view of one embodiment of a truck driving simulator;

FIG. 8 is a cross-sectional view across the lines 8,9 of FIG. 7, showing one embodiment of a knob mechanism, wherein the knobs are in an “out” position;

FIG. 9 is a cross-sectional view across the lines 8,9 of FIG. 7, showing one embodiment of a knob mechanism, wherein the knobs are in an “in” position;

FIG. 10 is a cross-sectional view of one embodiment of a knob mechanism positioned behind the dashboard of a truck driving simulator along the lines 10-10 in FIG. 8, wherein the knob is in an “in” position and the springs are positioned within a gap of a sleeve surrounding a knob shaft; and

FIG. 11 is a cross-sectional view of one embodiment of a knob mechanism positioned behind the dashboard of a truck driving simulator along the lines 11-11 in FIG. 9, wherein the knob is in an “out” position and the springs are positioned around a sleeve surrounding a knob shaft.

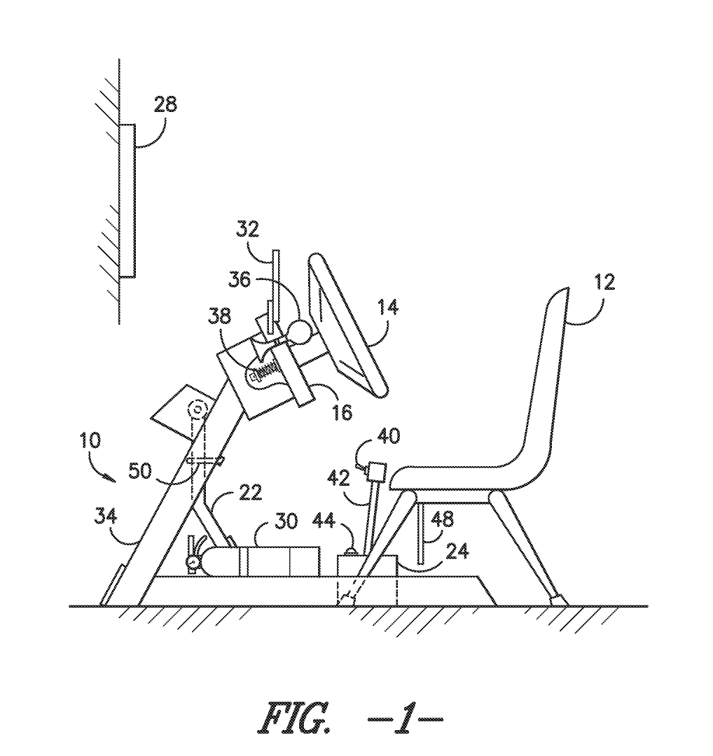

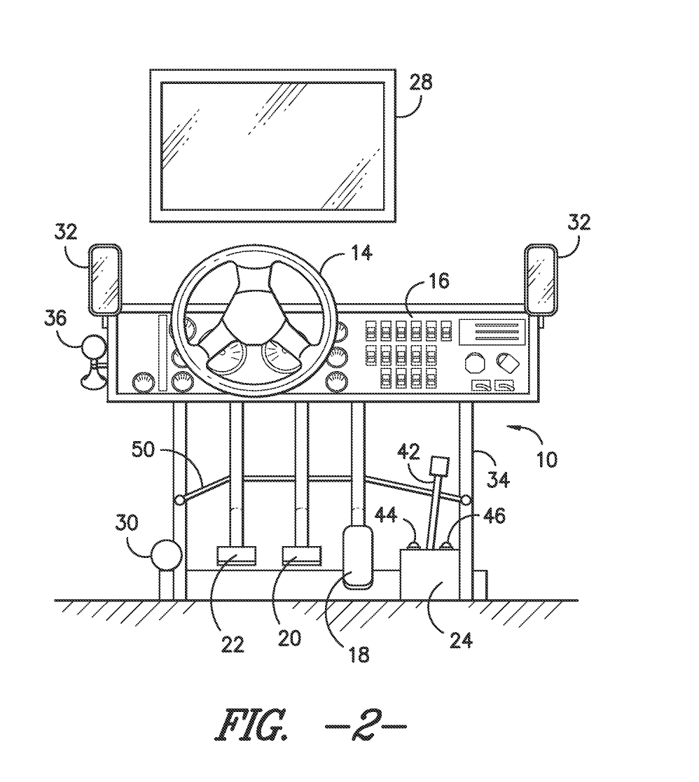

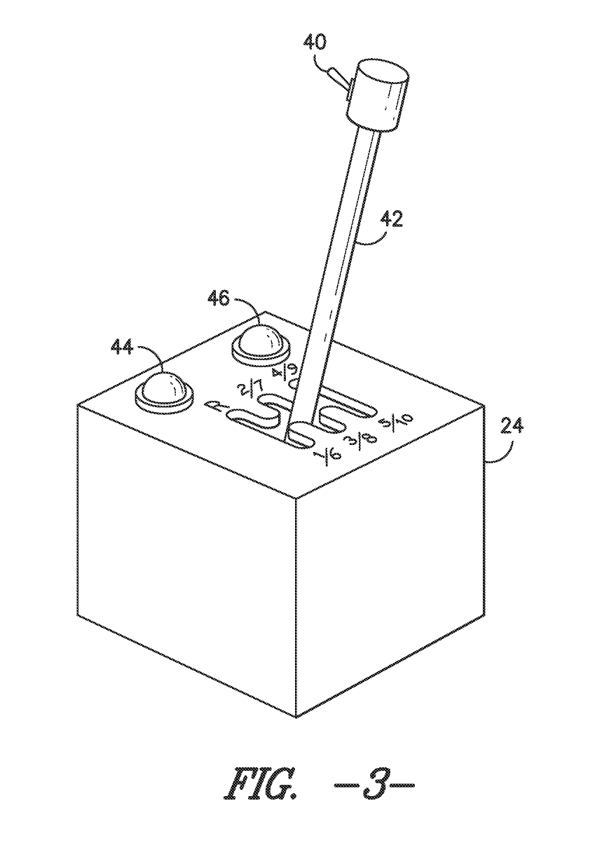

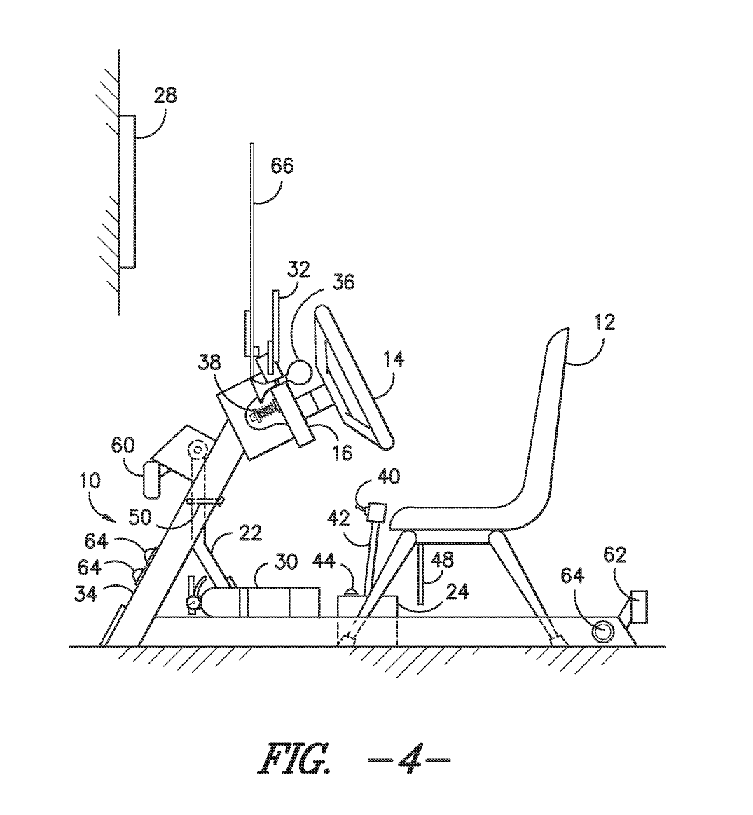

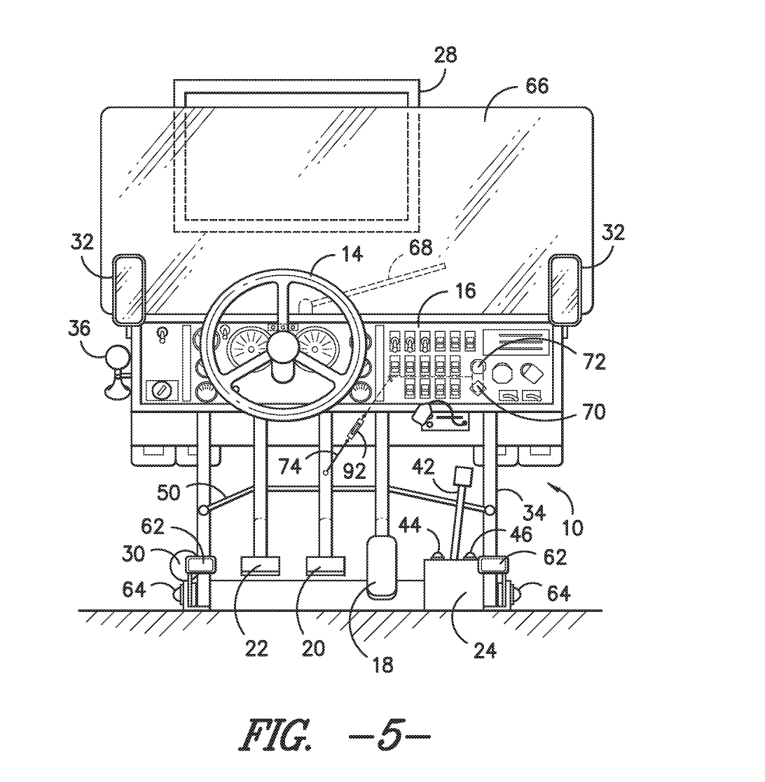

### DETAILED DESCRIPTION OF THE INVENTION

The present invention includes a truck driver simulator 10 and teaching method for providing instruction to a student driver regarding the operation of an eighteen-wheeler style truck. In one embodiment, a simulator 10 includes a driver's seat 12, steering wheel 14 and simulated dashboard 16, foot pedals accelerator 18, brake 20, and clutch 22) and a gear shift assembly 24 having a high/low gear indicator 44 and 46, all of which is designed to simulate the inside of a cab of a tractor trailer. The simulator 10 preferably includes a frame 34 with the above-referenced components attached thereto, and further includes a video monitor 28 or television screen. A fire extinguisher 30 and an emergency road hazard kit 48 are provided adjacent the driver's seat 12, so that a student driver may become familiar with the location of each in case of emergencies. Rear view mirrors 32 may be mounted in appropriate positions on the simulator frame 34, and a horn 36 may be included, as well.

The steering wheel 14 may include a spring mechanism 38 on a back side thereof to provide some resistance to turning the wheel. The high/low gear indicator 44 and 46, in one embodiment, is electrically connected to a three-way button or switch 40 located on an upper portion of the gear shift 42. One position of the switch 40 illuminates a light 44 to indicate high gear, a second position turns on a light 46 to indicate low gear, and the third position turns the indicator light(s) off. The indicator itself may include lights (as shown) or other means to indicate whether the transmission is in the higher gears or the lower gears. Generally, in a preferred embodiment, components of the simulator are made from inexpensive, common items. For instance, the shafts of the foot pedals (18, 20 and 22) may be made from PVC pipe, or the like, and a stretch cord 50 may be stretched between the frame 34 and behind the foot pedals (18, 20, 22) in order to provide resistance when the foot pedals (18, 20, 22) are depressed. Additionally, the gear shift 42 may be made from PVC, or from a bathroom plunger that is affixed to the bottom of the gear shift box.

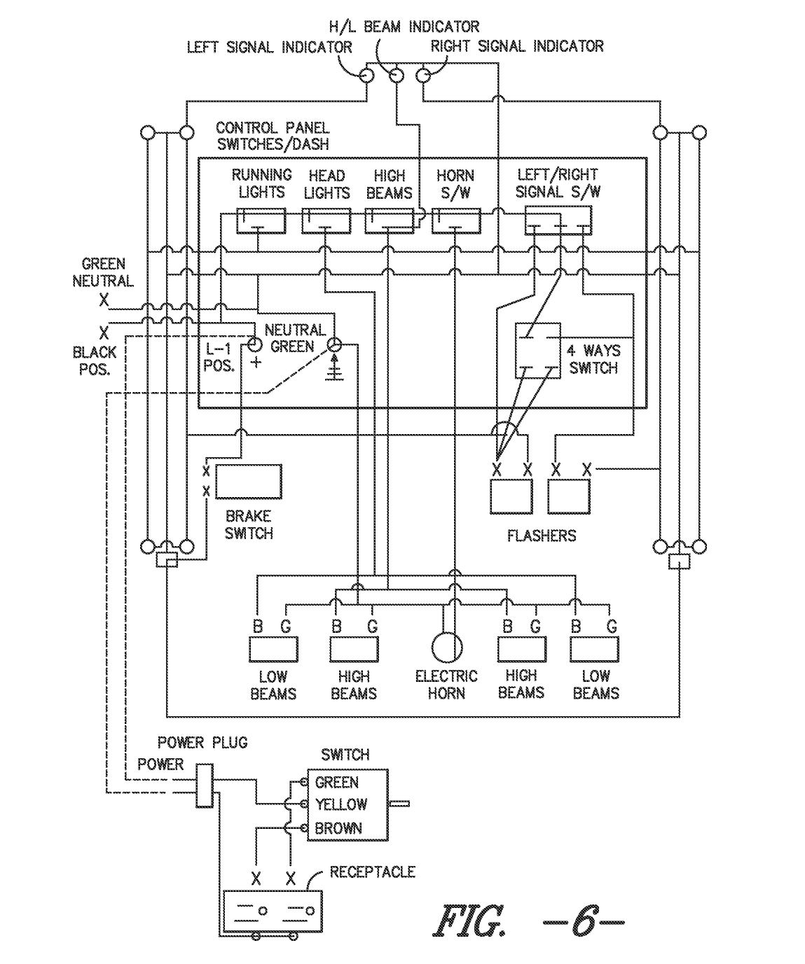

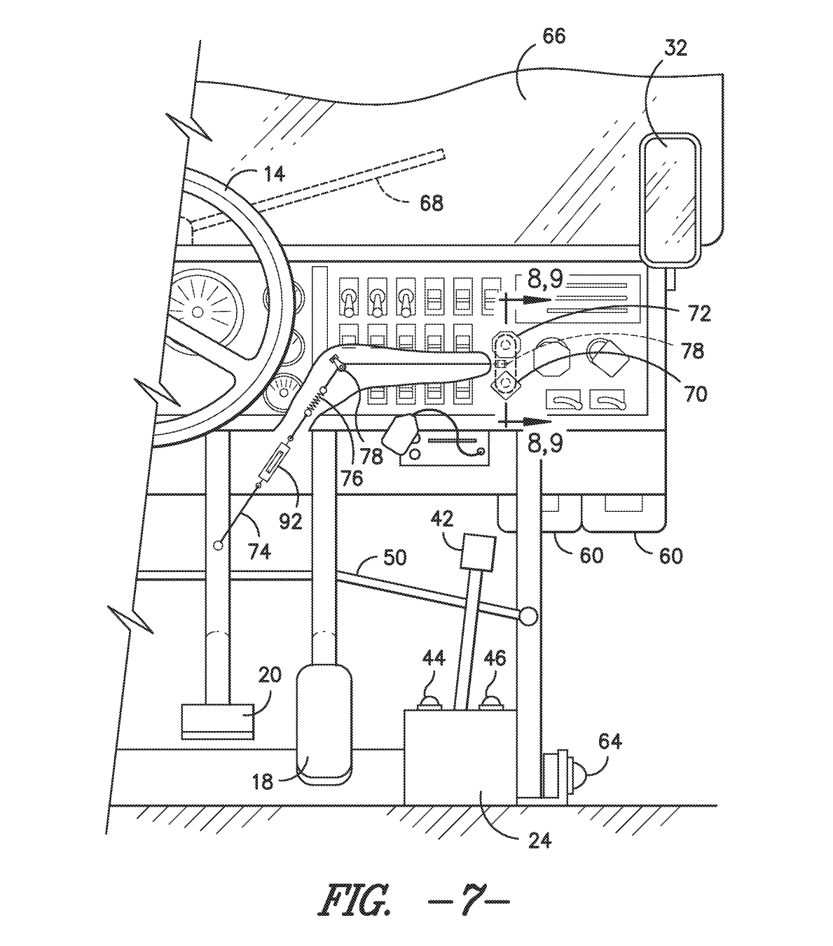

In one embodiment, the simulator may include a switch for headlights, and may include electrically connected headlights 60 (with bright light and dim light settings), as well as tail lights 62, running lights 64, and a switch for electrically operational hazard lights. Right and left blinkers may be included as well (which may be incorporated into the running lights 64), along with a switch or mechanism to activate the blinker lights. FIG. 6 represents a wiring schematic to connect the various electrical components to their switches, actuators and power source. A windshield 66 with windshield wipers 68 may be included, as well.

In a preferred embodiment, knobs for operating a parking brake (knob 70) and a trailer air supply (knob 72) may be included on the dash board, and may be operationally connected to the brake pedal 20 by a mechanical apparatus, so that a driver-in-training may push the knobs 70, 72 inwardly (into the “in” position) away from the dashboard 16 as part of the driving simulation, and by depressing the brake pedal 20 during the pre-driving checklist (as one would do if driving an actual tractor trailer rig), the knobs 70, 72 automatically pop back into the original “out” position.

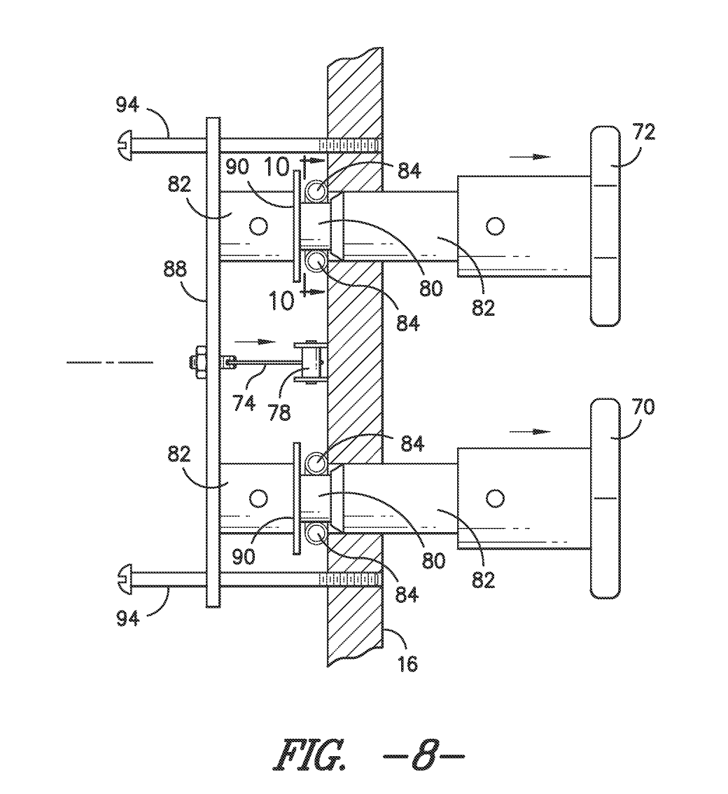

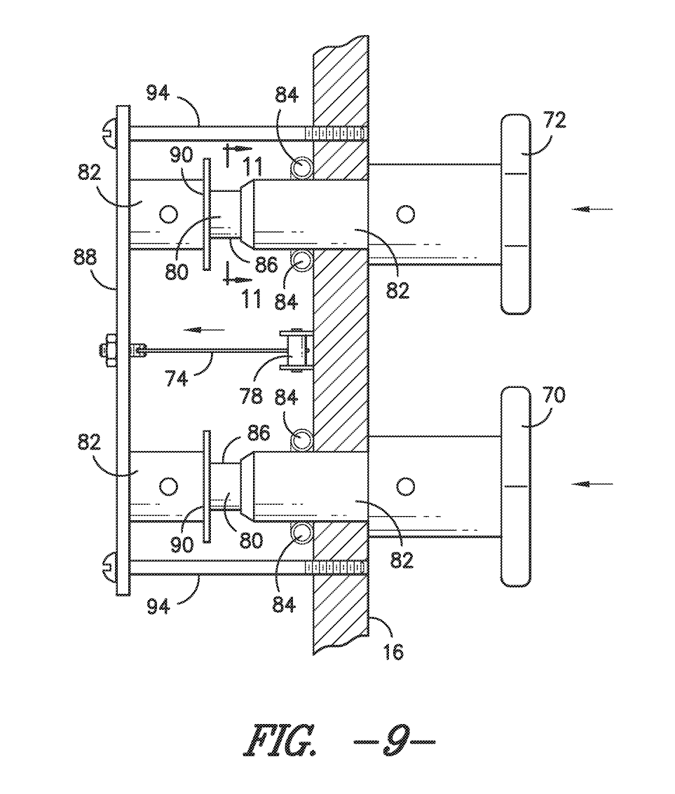

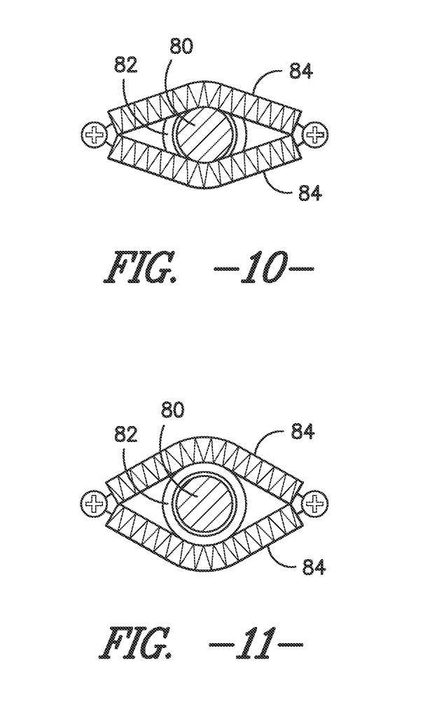

The mechanism that operatively connects the parking brake knob 70 and trailer air supply knob 72 with the brake pedal 20 include a cable extending between the knobs 70, 72 and the brake pedal 20. A spring 76 may be interposed along the cable in order to provide additional force as the brake pedal 20 is depressed, as shown, and pulleys 78 system provides the proper force in the appropriate direction to force the knobs 70, 72 back into the “in” position. Additionally, an adjustable buckle may be interposed along the cable, in order to adjust the tension of the cable. In one embodiment, the knobs 70, 72 include a post or shaft 80 surrounded by a sleeve 82 (preferably made from PVC pipe), so that the post 80 and sleeve 82 pass through a hole in the simulated dash board 16. On the backside of the dashboard 16, each hole where the post 80 and sleeve 82 pass includes a pair of springs 84 that surround the hole, as shown in FIGS. 10 and 11. The sleeve 82 is disposed about the post in two sections, with a gap 86 in between, as shown in FIGS. 8 and 9. When the knobs 70, 72 are in the “out” position, as shown in FIG. 8, the springs 84 on either side of the hole contract into the gap 86 between the sleeve 82, and come into contact with the underlying post 80. The end of each post 80 on a backside thereof (opposite the knobs 70, 72) is attached to a rigid plate 88. The plate may be slidably engaged along a pair of guide screws 94, as shown. The cable 74 attached to the brake pedal 20 runs through a pulley 78 that is attached to the backside of the dashboard 16 between the posts 80 and is attached to the plate 88. Thus, when the brake pedal 20 is depressed, the cable 74 is pulled through the pulleys 78, and forces the plate 88 inwardly toward the back side of the dashboard 16, which in turn forces the knobs 70, 72 outwardly from the front of the dashboard 16 into the “out position,” as shown in FIG. 8. Thus, when a driver-in-training pushes the knobs 70, 72 inwardly to the “in” position, as shown in FIG. 9, it forces the sleeve 82 through the springs 84 that are surrounding the hole, so that the springs 84 are no longer positioned within the gap 86 of the sleeve 82. When the brake pedal 20 is depressed, the cable 74 pulls the plate 88 and the knobs 70, 72 back to the “out” position, so that the springs 84 around each hole pop back into the gap 86 within the sleeve 82 around the posts 80, as shown. This arrangement allows the knobs 70, 72 to snap back into the “out” position when the brake pedal 20 is depressed. A washer 90 may be placed in the gap 86 and around the post 80 adjacent the outlying portion of sleeve 82 (farthest from the back of the dashboard 16), as a stopping mechanism for the knobs 70, 72.

The video monitor 28 is used to show footage that simulates driving through a road course, so that a student sitting in the simulator can simply follow along with the video footage by simulating or mimicking all of the activities associated with driving the truck. In one embodiment, each simulator may include a video monitor 28. In a second embodiment, a series of simulators may be placed into a classroom or teaching area, and a single large screen video monitor 28 may be used in conjunction with all of the simulators.

During the training, the student driver turns the steering wheel 14 at the appropriate times while following along with the video on the monitor 28, shifts gears through an appropriate shift pattern, accelerates, brakes and identifies road signs, bridge clearances, and other important signs, all under the supervision of an instructor. Preferably, the video includes actual footage from the road course that will be used to test the student for his or her truck driver's license. As the video progresses through the road course and the students are following along by simulating the driving activity corresponding with the video, an instructor watches the students and instructs them as necessary. This arrangement allows a close simulation of the driver's test, including not only instruction from the instructor, but also questions from the instructor that may simulate questions asked by the examiner during the test.

Additionally, the simulator may also be used to provide practice for a particular run. Video may be provided to show tricky or problem traffic areas, so that a driver will understand how to navigate through particular areas or cities on an upcoming run.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method for training a person to operate an eighteen wheeler style truck, said method comprising the steps of:
providing a simulation of a truck cab, including a steering wheel, accelerator pedal, brake pedal, clutch pedal and gear shift mechanism, and a dashboard having knobs for parking brake and trailer air supply, wherein said knobs are operatively connected to said brake pedal so that said knobs may be manually pressed to an ‘in’ position, and depressing said brake forces said knobs back to an ‘out’ position;
providing a video monitor showing video of a driving route;
allowing a student driver to watch said video monitor while mimicking driving activity corresponding to said video by turning said steering wheel, depressing said accelerator, depressing said clutch, depressing said brake, shifting said gear shift mechanism; and
providing an instructor to analyze said student driver, offer instruction, and ask questions to simulate questions of an official license examiner.

2. The method set forth in claim 1, further comprising the step of showing a video of a road course that said student driver must master in order to receive a license.

3. The method set forth in claim 1, further comprising the step of providing multiple truck cab simulations and a single large screen video, so that multiple students may participate in a training session.

4. A truck driving simulator comprising:
a frame member;
a seat attached to said frame member;
a dashboard connected to said frame member, said dashboard having a steering wheel attached thereto, said dashboard also including a windshield on a top portion thereof, a headlight switch, and a pair of knobs representing parking brakes and a trailer air supply;
an accelerator pedal, a brake pedal and a clutch pedal pivotally connected to said frame member and extending downwardly beneath said dashboard;
said brake pedal operatively connected to said knobs, which may be manually pressed inwardly toward the dashboard to an “in” position, and wherein depressing said brake pedal causes said knobs to move back to an “out” position away from said dashboard;
a gear shifting mechanism attached to said frame member adjacent said seat, said gear shift mechanism including an electrical switch operationally connected to tight indicators for identifying high gears or low gears;
headlights attached to said frame member, and electrically connected to a switch positioned on said dashboard;
electrically operational tail lights attached to said frame member on a rear portion thereof; and
a video monitor positioned adjacent a front of said simulator.

5. The truck simulator set forth in claim 4, further including a fire extinguisher attached to said frame member.

6. The truck simulator set forth in claim 4, further including running lights attached to said frame member and electrically connected to a switch positioned on said dashboard.

7. The truck simulator set forth in claim 4, further including a turn indicator switch attached to said dashboard adjacent said steering wheel, wherein said turn indicator is electrically connected to turn indicator lights, which are attached to said frame member.

8. The truck simulator set forth in claim 4, further including a high beam/low beam switch connected to said dashboard, wherein said high beam/low beam switch is electrically connected to said headlights.
